(19) United States
(12) Patent Application Publication
(10) Pub. No.: US 2005/0213347 A1
(43) Pub. Date: Sep. 29, 2005

(54) Light-guidance plate for flat light surfaces

(76) Inventor: Nobutaka Kajiura, Abiko-Shi (JP)

Correspondence Address: DELLETT AND WALTERS, P. O. BOX 2786, PORTLAND, OR, 97208-2786, US

(21) Appl. No.: 11/070,274

(22) Filed: Mar. 1, 2005

(30) Foreign Application Priority Data
Mar. 23, 2004 (JP) 2004-083916

(51) Int. Cl. F21V 7/04

(52) U.S. Cl. 362/615

(57) ABSTRACT

The invention relates to a bright light-guidance plate for flat light sources, which is easy to fabricate, makes a surface luminance distribution easily uniform and so the efficiency of utilization of light high, and ensures a display surface having a variation-free uniform luminance even when used as a backlight or the like for a transmission type liquid crystal display, and provides a light-guidance plate for flat light sources used as a surface form of light source, which comprises a transparent plate substrate 1 such that light from a light source 10 located facing one peripheral end face 15 thereof is entered in the transparent plate substrate 1 from the end face facing the light source, and light guided through internal reflection is scattered by a scatterer source located on one surface of the transparent plate substrate toward the front surface 11 side of the transparent plate substrate, leaving the transparent plate substrate. The scatterer source comprising linear grooves 21 is located on one surface 12 of the transparent plate substrate. The spacing between, and the depth of, the grooves 21 vary in such a smooth way that the luminance of light scattered toward the front surface 11 side of the transparent plate substrate becomes substantially uniform across the front surface.

### BACKGROUND OF THE INVENTION

The present invention relates generally to a light-guidance plate for flat light surfaces, and more particularly to a light-guidance plate for flat light surfaces that is used, for instance, for backlights in transmission type liquid crystal display devices.

For providing uniform illumination to, for instance, a transmission type liquid crystal display from its back surface, there is known a light-guidance plate for flat light sources, which has on its back surface a scatterer source comprising V-shaped minute reflecting facets, with a linear light source or sources located along one side or both sides. Generally, that light-guidance plate has a wedge-like shape in section orthogonal to the linear light source, with its thickness becoming small with distance from the linear light source (for instance, patent publications 1 and 2).

With such a light-guidance plate wherein minute reflecting facets comprising V-grooves or quadrangular cones are uniformly located as the scatterer source on the back surface, the surface luminance distribution of light scattered toward the front surface side of the light-guidance plate is less likely to become uniform. In the prior art, therefore, distribution has been somehow provided to the density of the scatterer source to make a surface luminance distribution uniform (for instance, patent publications 1 and 2).

Patent Publication 1

JP (A) 10-20125

Patent Publication 2

JP(A)11-286558

However, it is difficult and expensive to make a mold capable of forming a scatterer source wherein minute scatterers such as quadrangular cones are arranged at different densities in two row-and-column directions. Although it is relatively easy to fabricate V-grooves at varying densities in an axial direction, on the other hand, it is difficult to obtain a light-guidance plate for flat light sources, wherein the surface luminance distribution of a light source in its longitudinal direction is made so uniform that high efficiency is achievable. Even though such a light-guidance plate is somehow fabricated, the efficiency of utilization of light would then drop when used as a transmission type liquid crystal display backlight, because of variations in the display surface luminance.

### SUMMARY OF THE INVENTION

In view of such problems with the prior art as described above, a primary object of the invention is to provide a bright light-guidance plate for flat light sources, which has a varying scatterer source density simultaneously with a depth distribution, thereby making surface luminance distribution easily uniform enough to have high efficiency of utilization of light, is helpful for reducing mold fabrication costs, and ensures variation-free, uniform display surface luminance even when used as a transmission type liquid crystal display backlight or the like.

According to the invention, this object is accomplishable by the provision of a light-guidance plate for flat light sources used as a surface form of light source, which comprises a transparent plate substrate such that light from a light source located facing one peripheral end face thereof is entered in the transparent plate substrate from the end face facing the light source, and light guided through internal reflection is scattered by a scatterer source located on one surface of the transparent plate substrate toward a front surface side of the transparent plate substrate, leaving the transparent plate substrate, wherein:

said scatterer source on said one surface of said transparent plate substrate comprises linear grooves or rows of linearly aligned conical pits, and said grooves or rows of conical pits have a smoothly varying spacing and depth such that the light scattered toward the front surface side of said transparent plate substrate has a substantially uniform luminance across the front surface.

In one specific embodiment of the invention, said transparent plate substrate is in a rectangular form with a linear light source located facing one side thereof, a plurality of said grooves or pit rows are located parallel with said one side, and said grooves or pit rows are positioned such that a spacing between said grooves or pit rows becomes small with distance from said linear light source and a curve indicative of a depth of each of said grooves or pit rows becomes minimum substantially at a center and increases toward both ends.

In another specific embodiment of the invention, said transparent plate substrate is in a rectangular form with linear light sources located facing opposite two sides thereof, a plurality of said grooves or pit rows are located parallel with said two sides, and said grooves or pit rows are positioned such that a spacing between said grooves or pit rows becomes small with distance from said linear light sources and reaches a minimum substantially at centers of said two sides and a curve indicative of a depth of each of said grooves or pit rows becomes minimum substantially at a center and increases toward both ends.

Throughout these embodiments of the invention, said transparent plate substrate that forms part of the light-guide plate for flat light sources may have a thickness that varies along a length thereof.

In accordance with the light-guidance plate for flat light sources according to the invention, the scatterer source comprising grooves or rows of conical pits is loated on one surface of the transparent plate substrate in such a way that its density and depth are proportional to a scattering coefficient, so that the luminance of light scattered toward the front surface side of the transparent plate substrate is substantially uniformly distributed within the front surface thereof. It is thus possible to provide a light-guidance plate for flat light sources, which is easy to fabricate, makes surface luminance distribution easily uniform enough to have high efficiency of utilization of light, and ensures variation-free, uniform display surface luminance even when used as a transmission type liquid crystal display backlight or the like.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is illustrative of the design principle of the light-guidance plate for flat light surfaces according to the invention.

FIG. 2 is a flowchart according to which the light-guidance plate of the invention for flat light surfaces is obtained.

FIGS. 3(a) and 3(b) are perspective views of the constructions of exemplary scatterers.

FIG. 4 is illustrative of the sectional area upon projection of scatterers and the aperture sectional area of a unit cell in the direction of incidence of light.

FIGS. 5(a) and 5(b) are a front view and a side view of the light-guidance plate for flat light sources according to Example 1 of the invention, respectively, and FIG. 5(c) is a partly enlarged view of the side view.

FIG. 6 is illustrative of the light-emission intensity distribution of a linear light source in the longitudinal direction.

FIG. 7 is indicative of the scattering coefficient distribution of the light-guidance plate according to Example 1.

FIG. 8 is indicative of the V-groove spacing (pitch) distribution of the light-guidance plate according to Example 1 in the X-axis direction.

FIG. 9 is indicative of the V-groove depth distribution of the light-guidance plate according to Example 1 in the Y-axis direction.

FIG. 10 is indicative of the luminance distribution of the light-guidance plate according to Example 1.

FIGS. 11(a) and 11(b) are a front view and a side view of the light-guidance plate for flat light sources according to Example 2 of the invention, respectively, and FIG. 11(c) is a partly enlarged view of the side view.

FIG. 12 is illustrative of the light-emission intensity distribution of a linear light source in the longitudinal direction.

FIG. 13 is indicative of the scattering coefficient distribution of the light-guidance plate according to Example 2.

FIG. 14 is indicative of the V-groove spacing (pitch) distribution of the light-guidance plate according to Example 2 in the X-axis direction.

FIG. 15 is indicative of the V-groove depth distribution of the light-guidance plate according to Example 2 in the Y-axis direction.

FIG. 16 is indicative of the luminance distribution of the light-guidance plate according to Example 2.

### DESCRIPTION OF THE PREFERRED EMBODIMENTS

Reference is now made to the principles of the light-guidance plate for flat light surfaces according to the invention as well as some embodiments of the light-guidance plate for flat light surfaces obtained on the principles.

First of all, the design principles of the light-guidance plate for flat light surfaces according to the invention are explained.

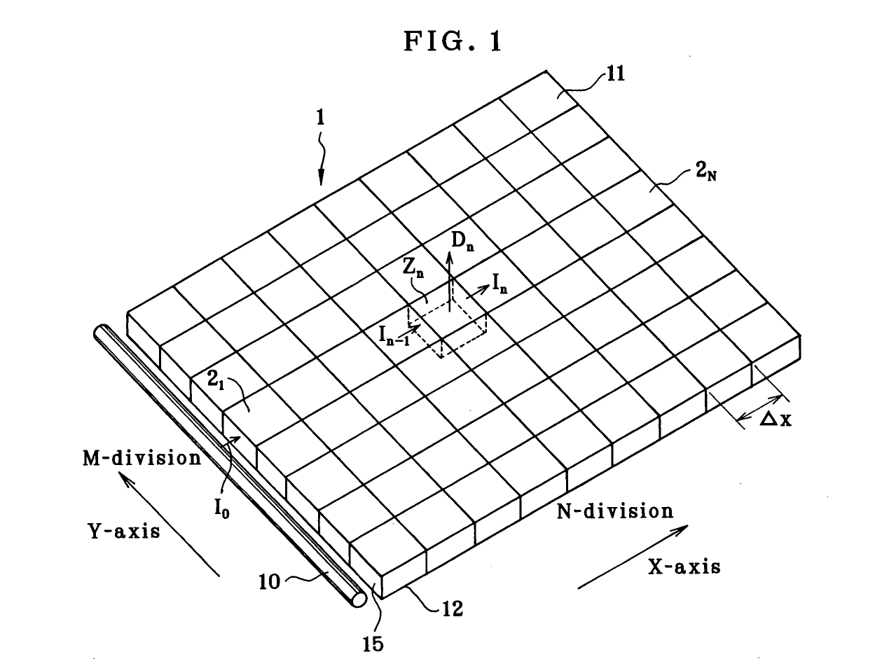

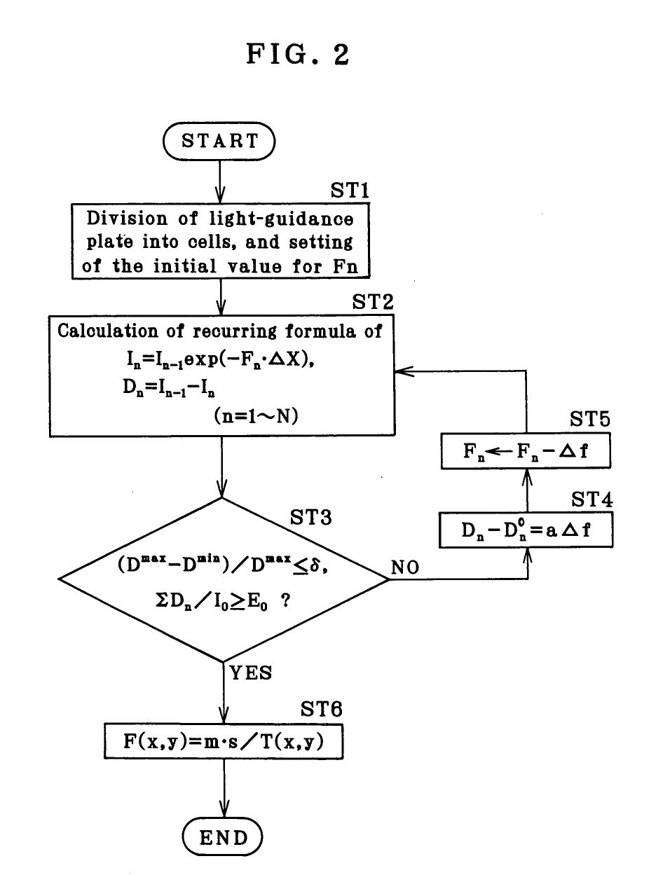

For the purpose of simplification, consider the case where a linear light source 10 is located, facing, and parallel with, one end face 15 of a light-guidance plate 1 having a rectangular contour, as shown in FIG. 1. Then, assume that Y- and X-axis directions are defined by the axial direction of the linear light source 10 and a direction orthogonal to the linear light source 10, respectively, and that light rays coming from the linear light source 10 in the X-axis direction alone enter the light-guidance plate 1 from one end face 15. Further, the light-guidance plate 1 is equally divided into N cells in the X-axis direction and M cells in the Y-axis direction. One of the thus obtained cells is designated by 2ₙ where “n” is an n-th cell as viewed from the side of the linear light source 10 in the X-axis direction. Furthermore, the initial value for the scattering coefficient Fₙ to be defined later is set. This step corresponds to step ST1 in FIG. 2 that is a flowchart for obtaining the light-guidance plate for flat light surface according to the invention.

For each cell 2ₙ, if the number of division N is large enough, the scattering coefficient within one cell 2ₙ can then be regarded as being constant and so given by Fₙ. Here let Iₙ₋₁ stand for the intensity of light incident on that cell 2ₙ, In represent the intensity of light leaving that cell 2ₙ, and Δx indicate the length of that cell 2ₙ in the X-axis direction. Then, the following equation holds:
Iₙ=Iₙ₋₁·exp(−FₙΔx) (1)
The intensity Dₙ of light scattered from the cell 2n is given by
Dₙ=Iₙ₋₁−Iₙ (2)
Then, calculation is made with equation (1) and recurring formula (2) from n=1 to n=N, provided that the intensity of light from the linear light source 10 on a cell 2₁ that faces the linear light source 10 is designated by I₀. This step corresponds to step ST2 in FIG. 2.

A surface variation (D^{max}−D^{min})/D^{max} where D^{max} and Dₘᵢₙ are the maximum and minimum values of scattered light in the surface of the light-guidance plate, respectively, and a scattering efficiency ΣDₙ/I₀ are found from the thus obtained intensity distribution Dₙ of scattered light for determining whether or not they satisfy the following conditions. This step corresponds to step ST3 in FIG. 2.
(D^{max}−D^{min})/D^{max}≦δ (3)
ΣDₙ/I₀≧E₀ (4)
Here, for instance, 0.05 (5%), preferably 0.005 (0.5%) and 0.7 (70%), preferably 0.9 (90%) are set for δ and E₀, respectively.

The first calculation of the above equation (1) is done with any given scattering coefficient Fₙ of the cell 2n (for instance, the same constant value is set for all cells); however, conditions (3) and (4) are generally not satisfied. In that case, such differences aΔfₙ as given by equation (5) below are found regarding n=1 to n=N by comparing the obtained scattered light intensity distribution Dₙ with the desired scattered light intensity distribution Dₙ⁰ (=a constant value). This step corresponds to step ST4 in FIG. 2.
Dₙ−Dₙ⁰=aΔfₙ (5)

Using Δfₙ proportional to the found difference aΔfₙ, the initial scattering coefficient Fₙ is corrected as given below into a new scattering coefficient Fₙ. This step corresponds to step ST5 in FIG. 2.
Fₙ←Fₙ−Δfₙ (7)

Using the thus corrected scattering coefficient Fₙ, the calculation of step ST2 is again performed to repeat a feedback loop involving step ST2 to step ST5 until conditions (3) and (4) are satisfied, thereby obtaining a distribution of scattering coefficient Fₙ that satisfies conditions (3) and (4).

Here, if x={(total length of light-guidance plate 1 in the X-axis direction)/N}×n, then the scattering coefficient Fₙ is expressed as F(x) that is a function of x.

While the invention has been explained with reference to the case where light rays come out of the linear light source 10 in the one-dimensional (X-axis) direction alone, it is to be understood that in a practical arrangement where light rays come out of the linear light source 10 in two-dimensional directions, the above calculations are performed all over the surface of the light-guidance plate 1 and along the total length of the linear light source 10 with polar coordinates as the coordinates, and the obtained results are again converted into X, Y coordinates, thereby obtaining a two-dimensional scattering coefficient F(x, y).

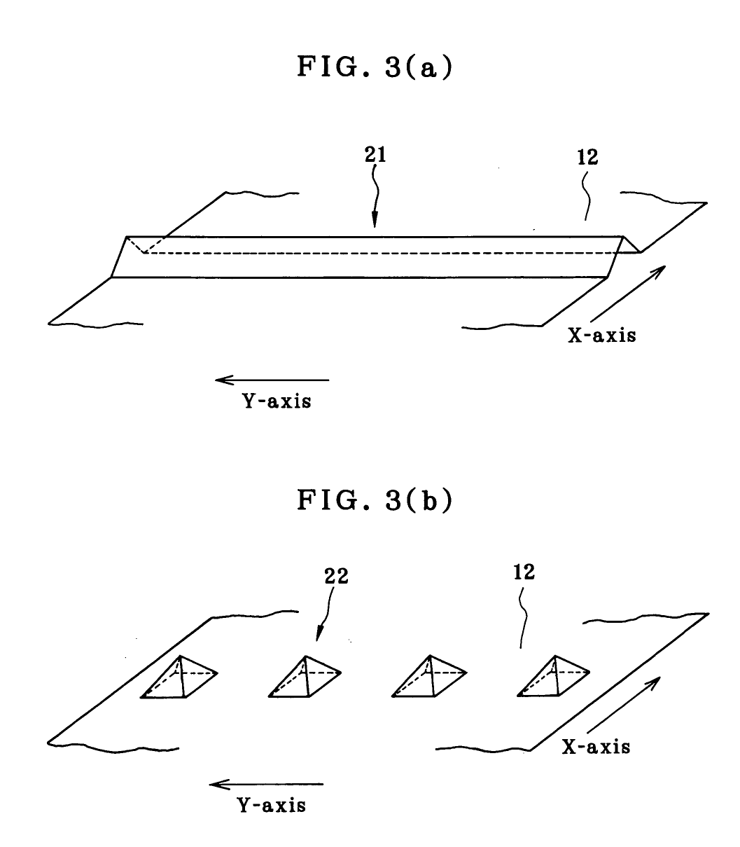

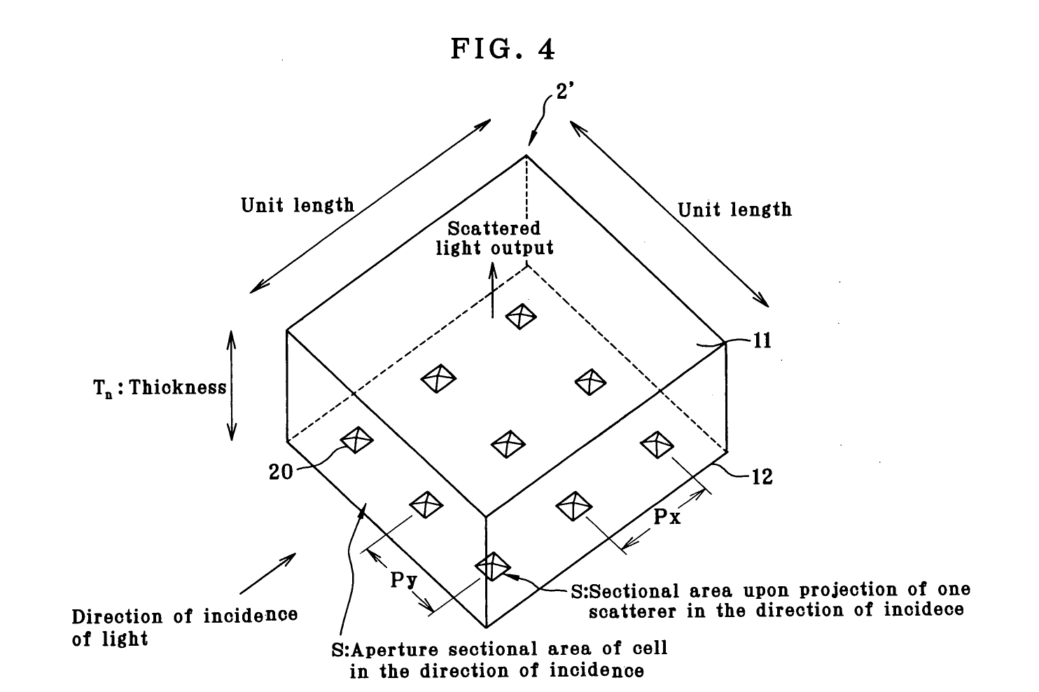

On the other hand, between the scattering coefficient Fₙ in one cell 2ₙ and a scatterer in that cell 2ₙ there is the following relation. A scatterer 20 assumed herein, for instance, comprises grooves 21 of V shape in section, which extend on the back surface 12 of cells 2ₙ in the Y-axis direction and are distributed in the X-axis direction, as shown in FIG. 3(a), or rows 22 of minute quadrangular cones that are aligned at a constant interval on the back surface 12 of cells 2ₙ in the Y-axis direction and distributed in the X-axis direction, as shown in FIG. 3(b). Here consider a unit cell 2′ that has a given unit length in the direction of incidence of light (X-axis direction) and a given unit length in a direction orthogonal thereto (Y-axis direction), as shown in FIG. 4. Then,
Fₙ=Σs/S (8)
where s is a sectional area upon projection of one scatterer 20 in the direction of incidence of light, and S is an aperture sectional area of the unit cell 2′ in the direction of incidence of light.

This equation (8) may be rewritten as
Fn=s/(Tₙ·Pₓ·P_{y}) (9)
where Pₓ and P_{y} are the repeating sizes (pitches) of the scatterer 20 in the unit cell 2′ in the X- and Y-axis directions, respectively, and Tₙ is the thickness of the unit cell 2′.

Alternatively, equation (8) may be rewritten as
Fₙ=m·s/Tₙ (10)
where m is the density (number) of scatterers 20 in the unit cell 2′.

From this equation (10), it is found that the scattering coefficient Fₙ is proportional to the total sum m·s of the sectional areas upon projection of all the scatterers 20 in the unit cell 2′ in the direction of incidence of light, and inversely proportional to the thickness Tₙ of the light-guidance plate 1. Therefore,
F(x,y)=m·s/T(x,y) (11)
where F(x, y) is the scattering coefficient of the light-guidance plate 1, and T(x, y) is the thickness of the light-guidance plate 1. Thus, the light-guidance plate 1 that gives the desired scattering light intensity distribution D(x, y) (=Dₙ⁰=a constant value) is obtained. This step corresponds to step ST6 in FIG. 2.

The present invention is now explained with reference to two examples of the light-guidance plate for flat light surfaces obtained on the principles of the invention.

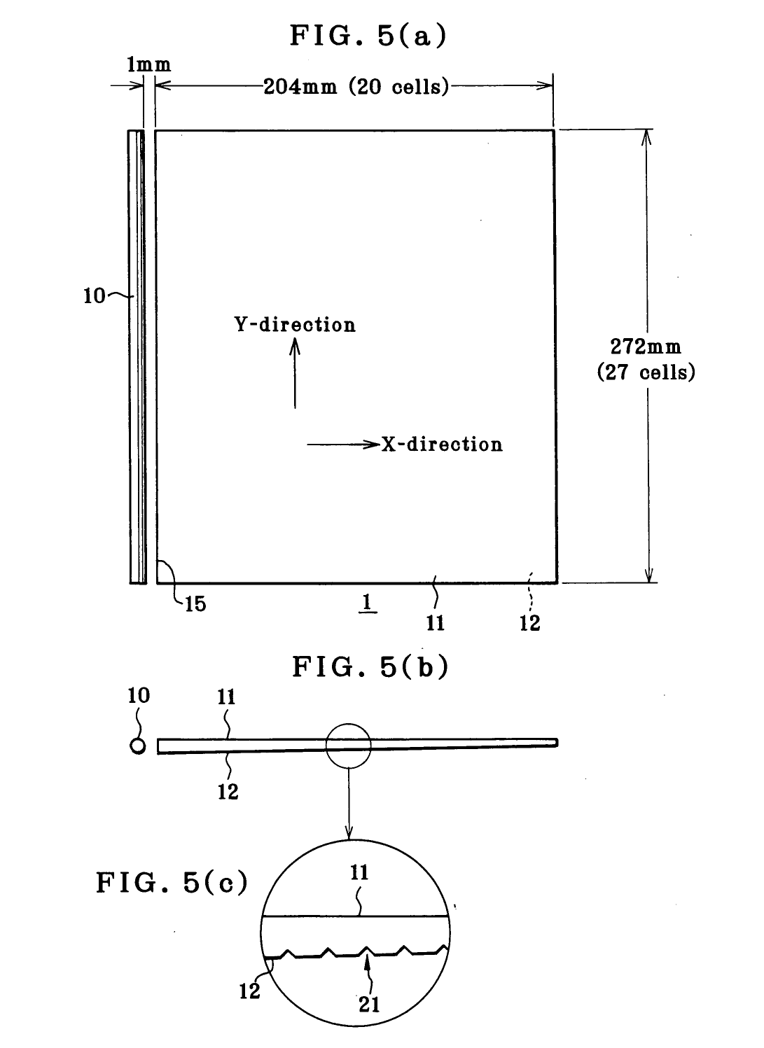

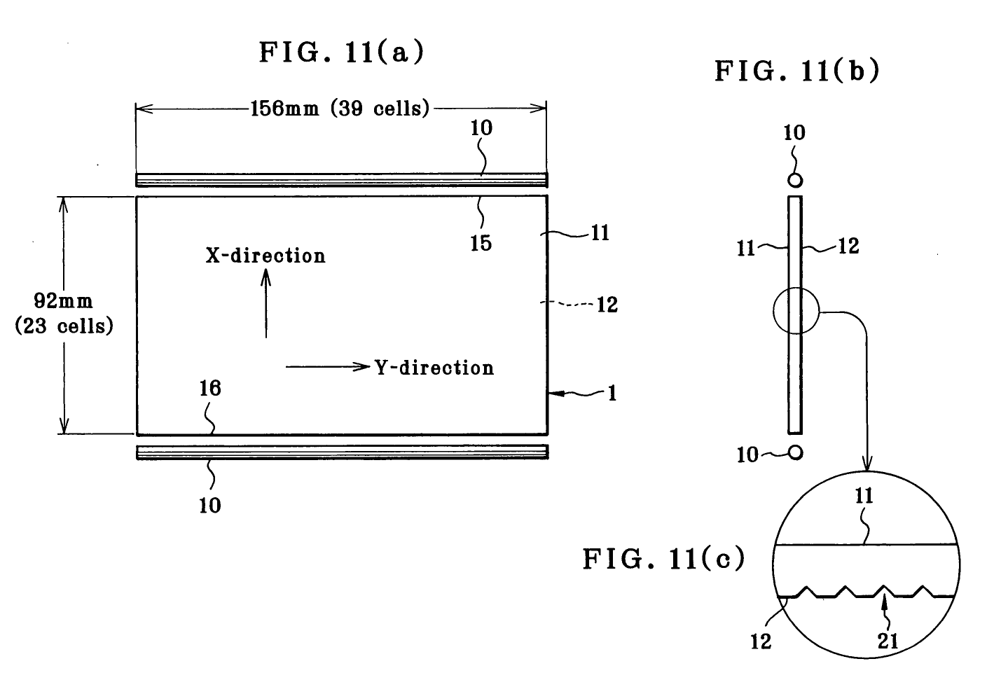

FIGS. 5(a) and 5(b) are a front view and a side view of the light-guidance plate 1 according to Example 1 of the invention, respectively, and FIG. 5(c) is a partly enlarged view of that side view. FIGS. 11(a) and 11(b) are a front view and a side view of the light-guidance plate 1 according to Example 2 of the invention, respectively, and FIG. 11(c) is a partly enlarged view of that side view.

In Example 1 of FIG. 5, there is provided a rectangular light-guidance plate 1 of 204 mm in the length of one side in the X-axis direction and 272 mm in the length of one side in the Y-axis direction. A linear light source 10 having the same length as the long side length of the light-guidance plate 1 is provided, facing one end face 15 of one long side thereof. Specifically, the linear light source 10 is spaced 1-mm away from one end face 15, and is configured into a wedge-like shape having a thickness decreasing from 2 mm on one end face 15 to 0.6 mm on the other end face. In calculation for FIG. 2, the light-guidance plate 1 is divided into 20 equal cells in the X-axis direction and 27 equal cells in the Y-axis direction. In the back surface 12 of the light-guidance plate 1 there are cut a multiplicity of parallel V-grooves 21 extending from outside in the Y-axis direction. Those V-grooves 21 have all a height of just 10 μm in the light-guidance plate 1 and at a center in the Y-axis direction, and the pitch between the V-grooves 21 extending in the Y-axis direction varies in the X-axis direction.

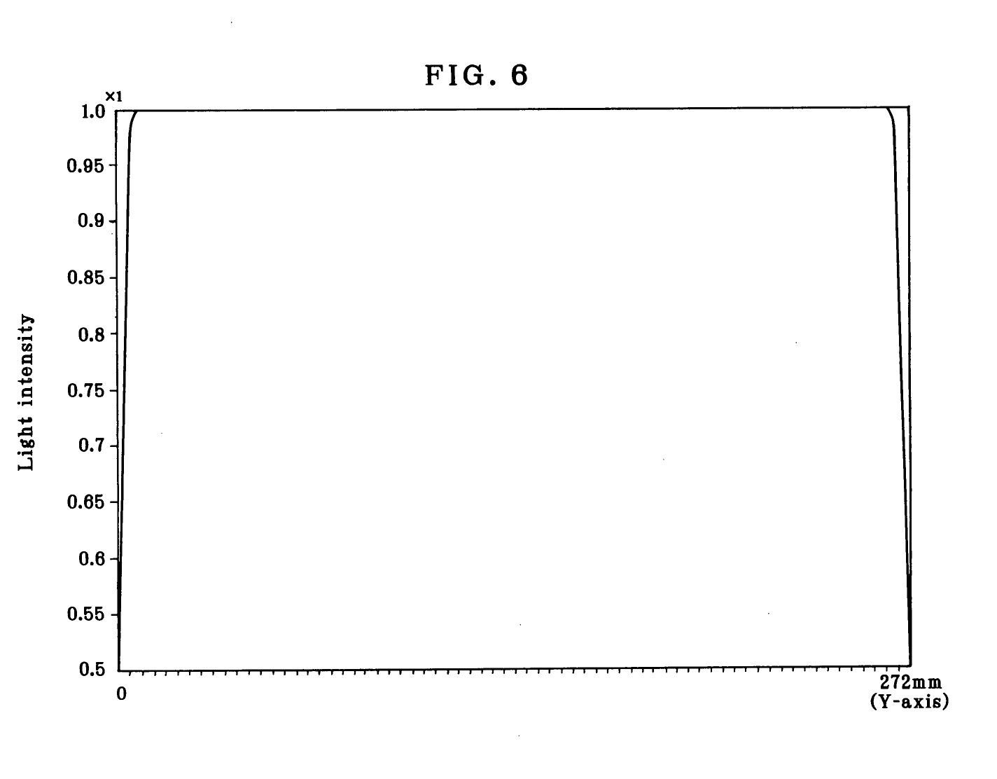

Here the linear light source 10 has such a longitudinal light-emission intensity distribution as shown in FIG. 6, provided that the intensity of light is normalized at 1.

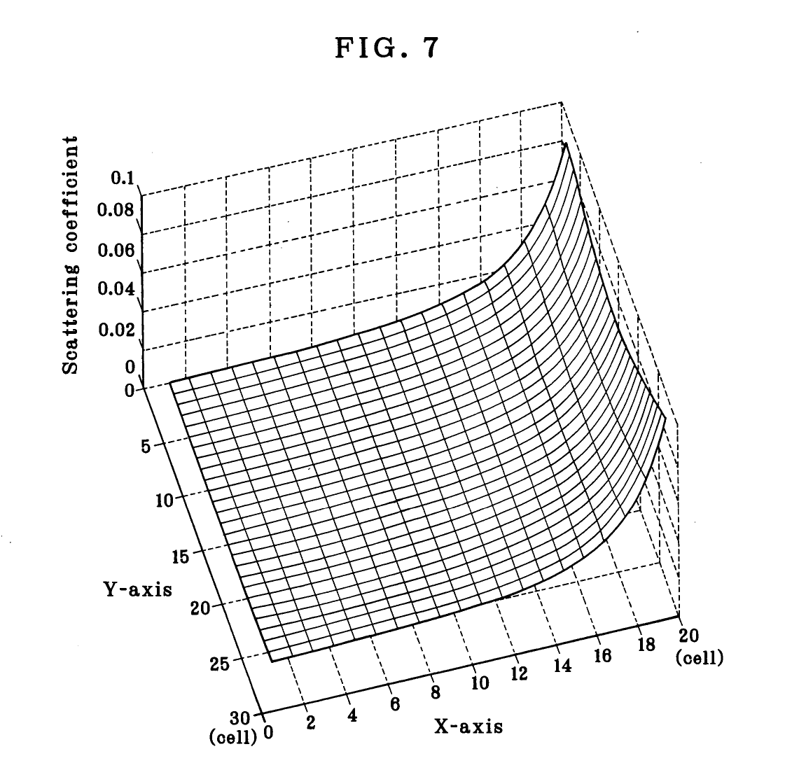

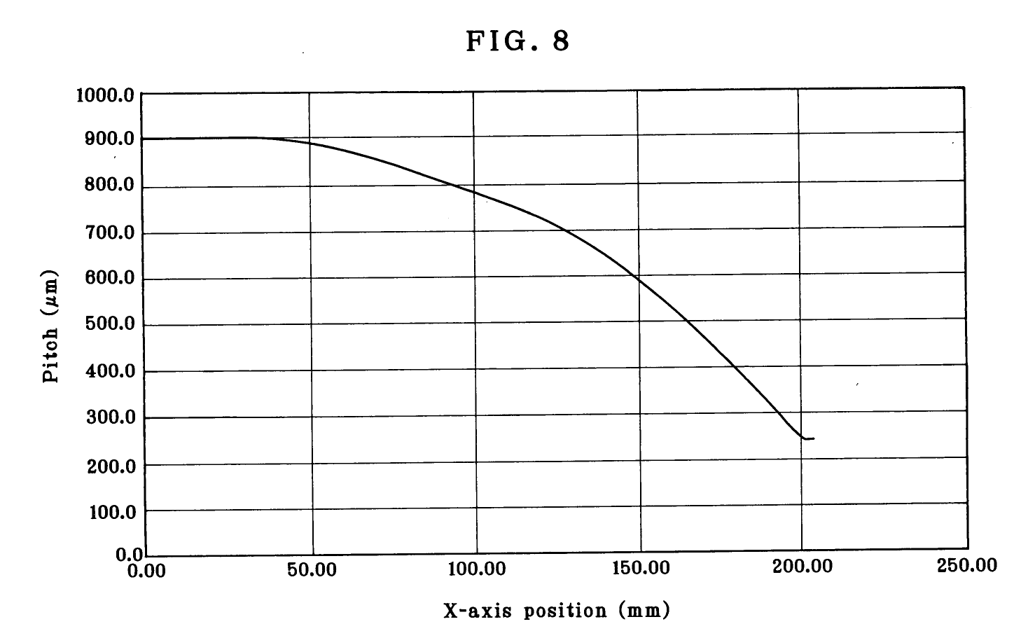

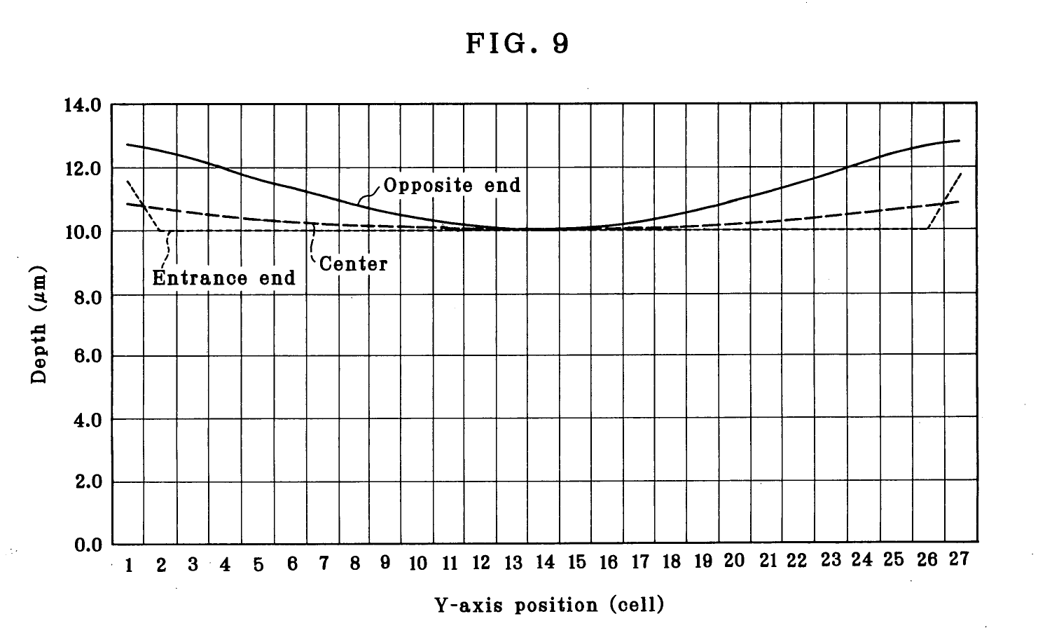

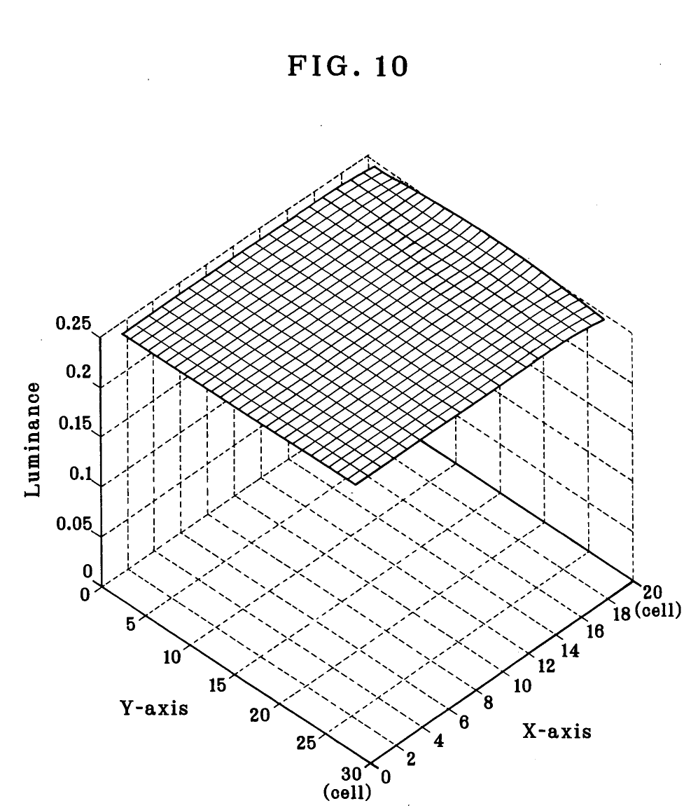

The light-guidance plate 1 of Example 1 has such a scattering coefficient distribution F(x, y) as shown in FIG. 7, the spacing (pitch) distribution of the V-grooves 21 in the X-axis direction, obtained therefrom, has such a form as shown in FIG. 8, and the depth distribution of each V-groove 21 in the Y-axis direction has such a form as shown in FIG. 9. The luminance distribution obtained on the surface 11 side of the light-guidance plate 1 according to Example 1 has such a form as shown in FIG. 10. However, it is noted that in FIGS. 7, 9 and 10, the numerals indicative of positions in the X- and Y-axis directions are cell numbers.

The light-guidance plate 1 obtained according to Example 1 has a surface symmetry D^{min}/D^{max} of 95% and a scattering efficiency ΣDₙ/I₀ of 75% or greater, indicating that the surface luminance distribution is extremely even and uniform. It is thus found that a light-guidance plate for flat light sources having an ever higher efficiency is obtainable according to the invention.

In this embodiment, the pitch between the V-grooves 21 becomes gradually small with distance from the linear light source 10, and the curve indicative of that pitch is upwardly convex and smooth, as can be seen from FIG. 8. The depth of each V-groove 21 becomes minimum substantially at the center even in any position on the X-axis and becomes large toward both ends, and the curve indicative of that depth is downwardly convex and smooth, as can be seen from FIG. 9. Each V-groove 21 becomes deeper at both ends than at the center with distance from the linear light source 10.

Referring then to Example 2 of FIGS. 11(a) and 11(b), there is provided a rectangular light-guidance plate 1 of 92 mm in the length of one side in the X-axis direction and 156 mm in the length of one side in the Y-axis direction. Linear light sources 10 and 10 having the same length as the long side length of the light-guidance plate 1 are provided, facing end faces 15 and 16 thereof. Specifically, the linear light sources 10 and 10 are spaced 1-mm away from the end faces 15 and 16, and are each made up of a plane-parallel plate having a uniform thickness of 5 mm along the end faces 15 and 16. In calculation for FIGS. 11(a) and 11(b), the light-guidance plate 1 is divided into 23 equal cells in the X-axis direction and 39 equal cells in the Y-axis direction. In the back surface 12 of the light-guidance plate 1 there are cut a multiplicity of parallel V-grooves 21 extending from outside in the Y-axis direction. Those V-grooves 21 have all a height of just 50 μm in the light-guidance plate 1 and at a center in the Y-axis direction, and the pitch between the V-grooves 21 extending in the Y-axis direction varies in the X-axis direction.

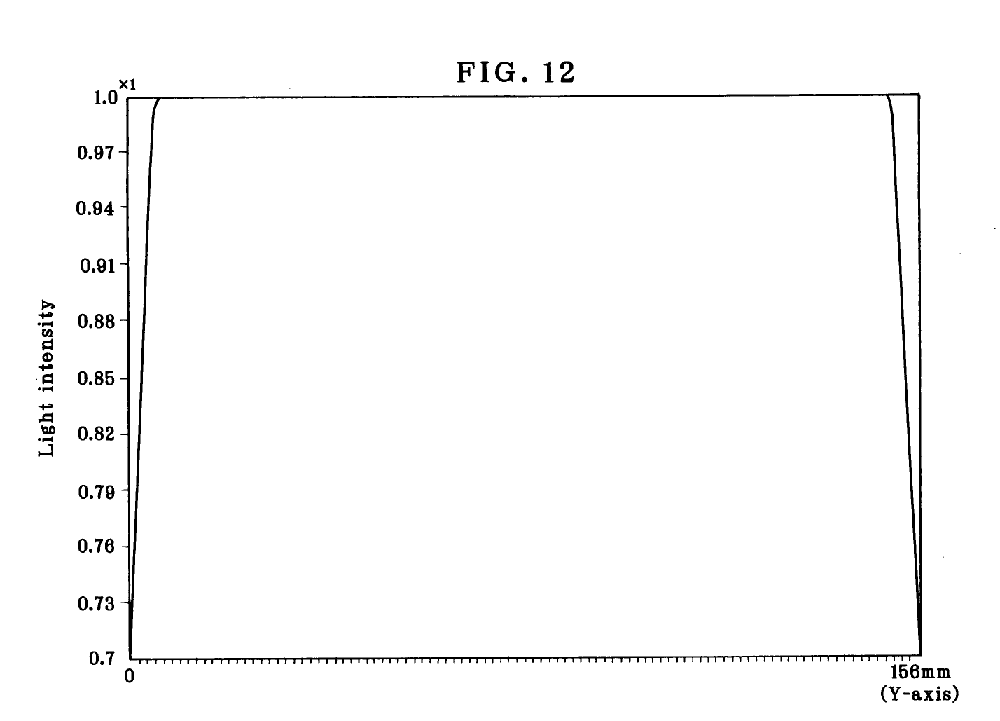

Here the linear light source 10 has such a longitudinal light-emission intensity distribution as shown in FIG. 12, provided that the intensity of light is normalized at 1.

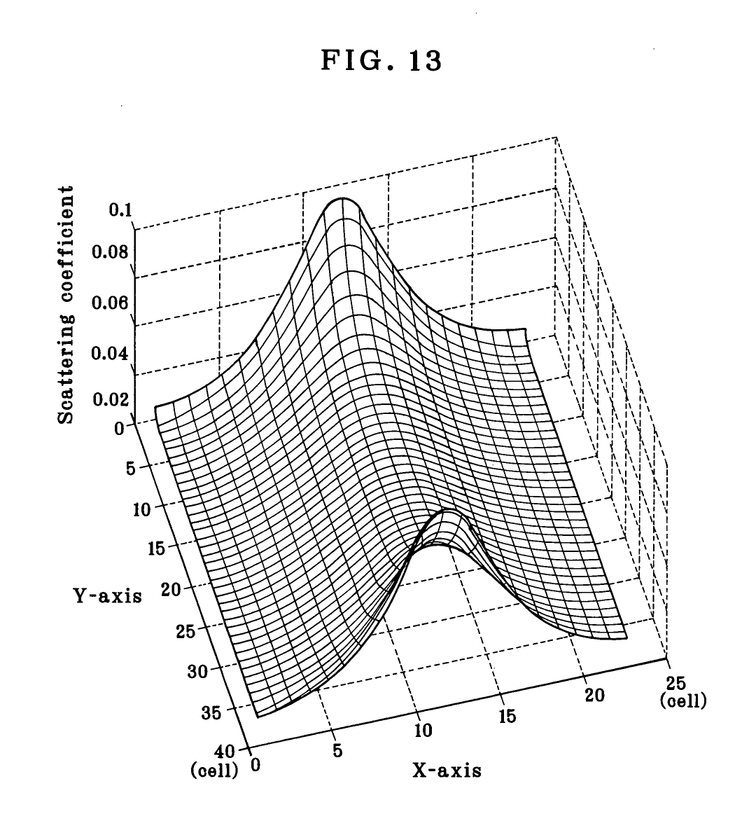

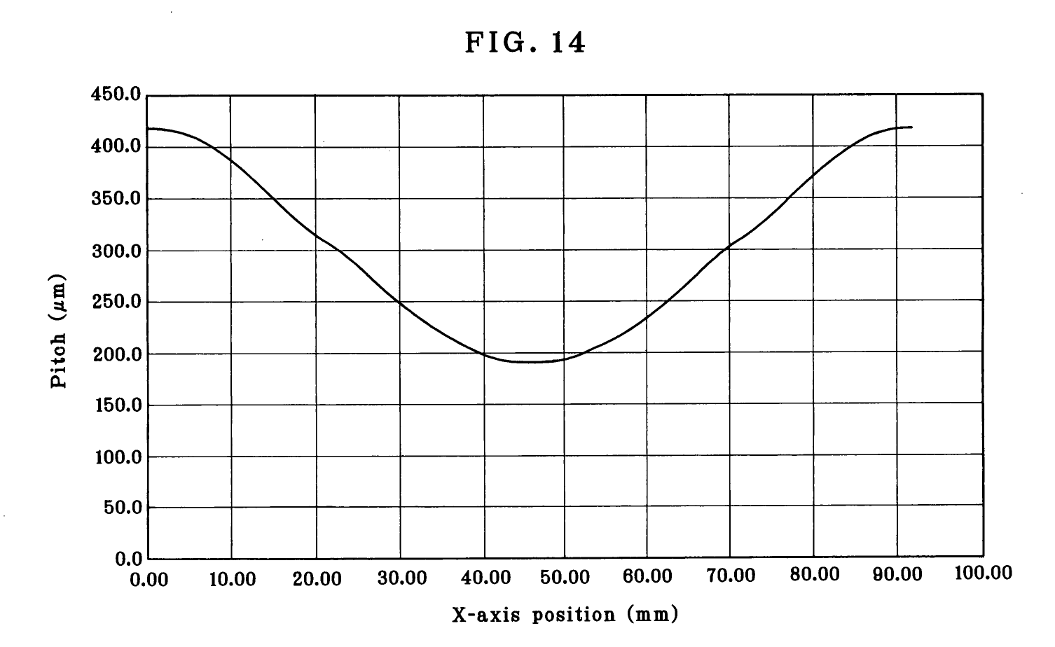

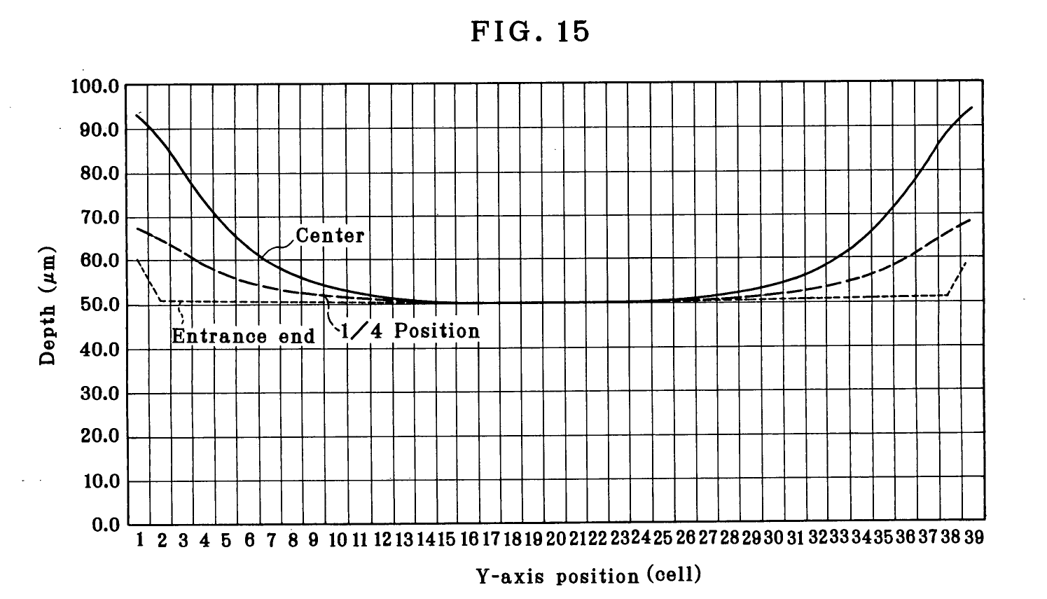

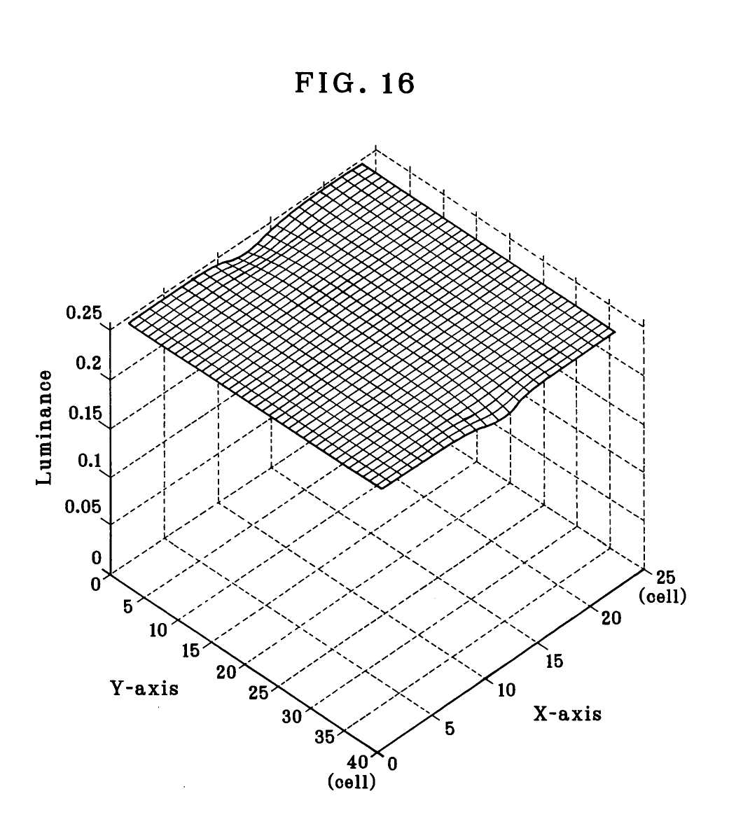

The light-guidance plate 1 of Example 2 has such a scattering coefficient distribution F(x, y) as shown in FIG. 13, the spacing (pitch) distribution of the V-grooves 21 in the X-axis direction, obtained therefrom, has such a form as shown in FIG. 14, and the depth distribution of each V-groove 21 in the Y-axis direction has such a form as shown in FIG. 15. The luminance distribution obtained on the surface 11 side of the light-guidance plate 1 according to Example 2 has such a form as shown in FIG. 16. However, it is noted that in FIGS. 13, 15 and 16, the numerals indicative of positions in the X- and Y-axis directions are cell numbers.

The light-guidance plate 1 obtained according to Example 2 has a surface symmetry D^{min}/D^{max} of 95% and a scattering efficiency ΣDₙ/I₀ of 80% or greater, indicating that the surface luminance distribution is extremely even and uniform. It is thus found that a light-guidance plate for flat light sources having an ever higher efficiency is obtainable according to the invention.

In this embodiment, the pitch between the V-grooves 21 becomes gradually small with distance from the linear light source 10 and becomes minimum substantially at the centers of the end faces 15 and 16, and the curve indicative of that pitch is downwardly convex and smooth such that it has points of inflection near the end faces 15 and 16 and a minimum value substantially at the centers thereof, as can be seen from FIG. 14. The depth of each V-groove 21 becomes minimum substantially at the center even in any position on the X-axis and becomes large toward both ends, and the curve indicative of that depth is downwardly convex and smooth, as can be seen from FIG. 15. Each V-groove 21 becomes deeper at both ends than at the center with distance from the linear light sources 10 toward the centers of the end faces 15 and 16.

While the invention has been described with reference to the specific examples using the linear light source 10, it is understood that when a point light source is used or a plurality of point light sources are used instead of the linear light source, too, it is possible to achieve a light-guidance plate for flat light sources, which has uniform luminance distribution and high efficiency of utilization of light.

Instead of the V-grooves 21, grooves of inverted trapezoid in section, U-shaped grooves, linear grooves or the like could be used. Alternatively, rows 22 of equidistantly and linearly aligned quadrangular cones as shown in FIG. 3(b) or cones could be used.

While the light-guidance plate for flat light sources according to the invention has been described with reference to its design principles and specific examples, it is understood that the invention is never limited thereto, and so may be modified in various manners.

1. A light-guidance plate for flat light sources used as a surface form of light source, which comprises a transparent plate substrate such that light from a light source located facing one end face of a periphery thereof is entered in the transparent plate substrate from the end face facing the light source, and light guided through internal reflection is scattered by a scatterer source located on one surface of the transparent plate substrate toward a front surface side of the transparent plate substrate, leaving the transparent plate substrate, wherein:
said scatterer source on said one surface of said transparent plate substrate comprises linear grooves or rows of linearly aligned conical pits, and said grooves or rows of conical pits having a smoothly varying spacing and depth such that the light scattered toward the front surface side of said transparent plate substrate has a substantially uniform luminance across the front surface.

2. The light-guidance plate for flat light sources according to claim 1, wherein said transparent plate substrate is in a rectangular form with a linear light source located facing one side thereof, a plurality of said grooves or pit rows are located parallel with said one side, and said grooves or pit rows are positioned such that a spacing between said grooves or pit rows becomes small with distance from said linear light source and a curve indicative of a depth of each of said grooves or pit rows becomes minimum substantially at a center and increases toward both ends.

3. The light-guidance plate for flat light sources according to claim 1, wherein said transparent plate substrate is in a rectangular form with linear light sources located facing opposite two sides thereof, a plurality of said grooves or pit rows are located parallel with said two sides, and said grooves or pit rows are positioned such that a spacing between said grooves or pit rows becomes small with distance from said linear light sources and reaches a minimum substantially at centers of said two sides and a curve indicative of a depth of each of said grooves or pit rows becomes minimum substantially at a center and increases toward both ends.

4. The light-guidance plate for flat light sources according to any one of claims 1 to 3, wherein said transparent plate substrate has a thickness that varies along a length thereof.
